(19) United States
(12) Patent Application Publication
(10) Pub. No.: US 2005/0224396 A1
(43) Pub. Date: Oct. 13, 2005

(54) Method and apparatus for separating out foreign objects from a material flow

(75) Inventor: Dierk Schroder, Hamburg (DE)

Correspondence Address: VENABLE LLP, P.O. BOX 34385, WASHINGTON, DC, 20045-9998, US

(73) Assignee: HAUNI Maschinenbau AG, Hamburg (DE)

(21) Appl. No.: 11/098,398

(22) Filed: Apr. 5, 2005

(30) Foreign Application Priority Data
Apr. 7, 2004 (DE) 10 2004 017 595.0

(51) Int. Cl. B03B 7/00; B07B 9/00

(52) U.S. Cl. 209/17

(57) ABSTRACT

A method for separating out foreign bodies from a material flow includes generating a material flow and transferring the material flow to a measuring section. At least one foreign body is detected in the material flow at the measuring section and the foreign body is removing from the material flow. The method includes moving the airflow along with and at substantially the same speed as the material flow between the detecting and removing steps.

### CROSS-REFERENCE TO RELATED APPLICATION

This application claims the priority of German Patent Application No. 10 2004 017 595.0, filed on Apr. 7, 2004, the subject matter of which is incorporated herein by reference.

### BACKGROUND OF THE INVENTION

The invention relates to a method and an apparatus for separating out foreign objects from a material flow. A method and apparatus of this type are disclosed, for example in German patent document DE 199 18 774 A1 and corresponding U.S. Pat. No. 6,332,543 B1.

### SUMMARY OF THE INVENTION

It is an object of the present invention to provide an efficient method and apparatus for separating out foreign bodies from a material flow.

The above and other objects are accomplished according to the invention by the provision of a method for separating out foreign bodies from a material flow, comprising: generating a material flow; transferring the material flow to a measuring section; detecting at least one foreign body in the material flow at the measuring section; removing the foreign body from the material flow; and moving an airflow along with and at substantially the same speed as the material flow between the detecting and removing steps.

By generating or providing an airflow with substantially the same speed as the material flow, at least for the time period between detection and removal of the foreign bodies, it is ensured that lightweight material flow components such as tobacco strips, which have a higher air resistance than foreign bodies such as rocks, do not travel different distances between the steps of detecting and removing of the foreign bodies. A certain amount of time is generally required for the detection of foreign bodies, so that a corresponding spatial and time distance exists between the location for detecting the foreign body and/or the measuring location, and the location where the foreign body is separated out from the flow. The method according to the invention thus prevents different material-flow components from moving at different speeds and furthermore prevents the separating out of the wrong components. Within the framework of this invention, the material flow refers in particular to a tobacco flow.

The method can be realized particularly easily if the material flow in the measuring section follows a free-fall trajectory. On the other hand, it is possible for the apparatus to have a relatively flat structural design if the material flow in the measuring section follows a parabolic flight trajectory.

The material flow speed and the airflow speed in the measuring section increases, in particular if the gravitational force acting upon the material contributes to the acceleration.

The flow of air in the measuring section is preferably generated from the outside, for example by blowing air into or suctioning air out of the measuring section. This airflow can help generate an airflow for which the speed matches that of the material flow.

For an embodiment where the measuring section is oriented at least partially in the direction of the earth's center, it is advantageous if the material flow in the measuring section moves inside a channel having a decreasing cross section in the material-flow direction, at least in some sections. Owing to the fact that the material flow moves in a downward direction, at least in some sections, the gravitational pull of the earth will accelerate the downward movement of the flow. To prevent the various components of the material flow from moving at different speeds, as a result of different air resistances, this embodiment of the method, makes use of the fact that the flow speed inside a channel with decreasing cross-sectional area will automatically increase. The cross-sectional area of at least some sections is preferably a function that depends on the square root of the drop depth for the material flow.

The object is furthermore achieved with an apparatus for separating out foreign bodies from a material flow, comprising: a feeding device including a channel having an inlet for receiving the material flow and having an end with an outlet, the channel cross section being reduced in a movement direction of the material flow, at least in some sections; a foreign body detection device having a scanning zone in the channel to detect foreign bodies in the material flow; and a removing device having a separating out location at the outlet to separate out the foreign bodies from the material flow.

An extremely efficient separating out of foreign bodies is consequently possible. Within the framework of this invention, the tobacco-flow outlet side in particular refers to the channel outlet in a downstream direction of the flow.

The apparatus according to the invention can be realized particularly easily if the channel has a rectangular cross section, wherein it is advantageous if the channel is positioned substantially vertically, at least in some sections. It is furthermore advantageous if an impact surface is provided on the channel inlet side for deflecting a tobacco flow, for example supplied by a standard conveyor as described in German patent document DE 199 18 774 A1, wherein the flow is subsequently conveyed in the direction of the channel.

The apparatus can have a relatively flat structural design if at least one channel wall is designed to follow at least in some sections a parabolic flight trajectory.

The cross-sectional area of a particularly preferred embodiment of the device according to the invention is a function that depends on the square root of the drop depth for the material flow, at least in some sections. A suction-air generator or a blast air generator is preferably provided to help generate a corresponding conveying airflow in the channel.

### BRIEF DESCRIPTION OF THE DRAWINGS

The invention is described in the following without restricting the general inventive idea with the aid of embodiments and by referring to the drawings, to which reference is expressly made for all details not further explained in the text.

FIG. 1 is a schematic cross-sectional representation of first embodiment of the device according to the invention, and

FIG. 2 is a schematic cross-sectional representation of a second embodiment of the device according to the invention.

### DETAILED DESCRIPTION OF THE INVENTION

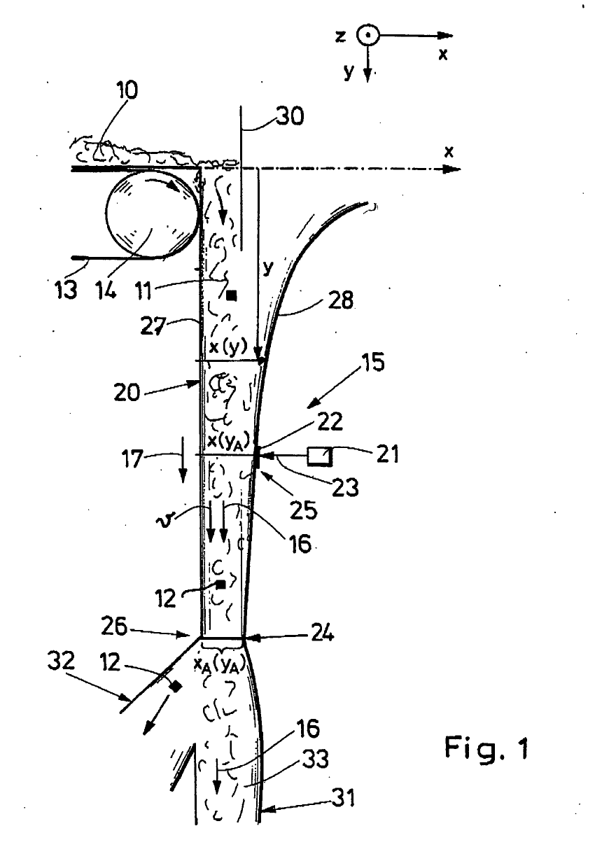

FIG. 1 shows a schematic cross-sectional representation of a first embodiment of the apparatus according to the invention for separating out foreign bodies. The material flow 10 is conveyed on a conveyor belt 13, that moves in the direction of the arrows and is deflected by a deflection roller 14, wherein the material is conveyed in the x direction until it hits an impact surface 30. The material flow 10, e.g. a tobacco flow containing tobacco 11 and foreign bodies 12, subsequently drops vertically downward into a chute and/or channel 20. The channel 20 comprises walls 27 and 28, having a constant depth in z direction which is perpendicular to the drawing plane for this embodiment. The width x in this case is a function of the drop depth y, meaning it is a square root function which is explained in further detail below.

The material flow 10 drops downward and moves through a measuring section 15 which comprises a scanning zone 25 and ends in a separating-out location 26. A window 22 is provided in the region of scanning zone 25 for allowing the light 23, emitted by an optical detection device 21, to pass through. The optical detection device 21 can comprise a laser for emitting a light beam 23 as well as a CCD line for measuring the light beam 23 reflection on the material flow 10 passing by. The CCD line preferably ensures the detection of foreign bodies 12 in the material flow 10 by means of a local resolution in z-direction. The optical detection device 21 can be embodied as described in German Patent document DE 199 18 774 A1, U.S. Pat. No. 6,332,543 B1, and German Patent Application 10 2004 015 463.5. The aforementioned patents and applications are herewith incorporated by reference into the present application.

Thus, it is easy to compute the time interval required for a detected foreign body 12 traveling at a predetermined material flow speed v in the movement direction 17 to reach the separating-out location 26. To eliminate the role of the air resistance, the speed of airflow 16 must match the speed v of the material flow 10, wherein this speed v increases with increasing drop depth y as a result of the gravitational pull of the earth.

At the separating-out location 26, the foreign body 12 is separated out or blown out into the separating-out chute 32 by a schematically indicated blow-out nozzle 24. The material flow 10 which is freed of foreign bodies 12 then enters the conveying-away chute 31 in the form of a tobacco flow 33 composed of tobacco 11 and cleaned of foreign bodies 12.

A different type of foreign-body detection device can also be used in place of an optical detection device, e.g. a device using heat, sound waves, or microwaves.

The respective airflow 16 for the embodiment shown in FIG. 1 is automatically increased or is generated by the airflow 16 carried along by the material flow 10. As a result, it is ensured that tobacco strips which have a higher air resistance due to a lower specific weight do not move at a slower speed than, for example, foreign bodies 12. It is therefore possible to precisely define the time difference between the instant when the foreign bodies are detected and the instant when they are separated out and/or removed at the separating-out location 26. Without this correspondingly adapted airflow 16, an undesirable amount of material (tobacco) would be separated out.

The apparatus described in German Patent document DE 199 18 774 A1 is used for measuring the material flow during a free fall, wherein a certain amount of time is required for evaluating the measuring signals. The material-flow components are subsequently blown out at a downstream location on the flight trajectory. In the process, the free-falling material is subjected to air resistance and the components in the flow of material are consequently delayed. Since the air resistance is primarily determined by the surface area, material components with large surfaces, such as tobacco strips, experience a higher delay than equally heavy components with a smaller surface, e.g. stones. Owing to this phenomenon, different types of material components move at different speeds between the detection location and the blow-out location. Thus, the material flow components in the apparatus disclosed in the foregoing German Patent document are subject to a type of speed dispersion, wherein this speed dispersion makes it impossible to precisely define the flight trajectory time for the various material flow components. As a result, material not representing a foreign body is erroneously blown out while at the same time foreign bodies are not blown out at all.

By contrast, the solution according to our invention avoids the speed dispersion, thus preventing the blow-out of material not representing a foreign body while ensuring that foreign bodies are definitely blown out. The invention involves intentionally generating an airflow having a trajectory that matches the trajectory for the material flow and/or the material component to be measured, meaning it moves at the same rate and in the same direction. The material flow and/or the measured material consequently is not delayed by the surrounding air, thereby avoiding the speed dispersion.

The material flow 10 for the exemplary embodiment shown in FIG. 1 is initially supplied horizontally on the conveyor belt 13, wherein the surface is positioned at height level y=0. At the end of the conveyor belt 13, the material drops into a chute with a rectangular cross section A(y)=x(y)·z, wherein z is assumed to be constant. The chute cross section x(y) must then be configured as follows.

The drop speed without air resistance is v_{y}=\sqrt{2·g·y}, wherein g is the acceleration due to gravity. The air speed should equal the drop speed at the blow-out location 26 y_{A}, thus making the drop speed at the blow-out location: v_{L}(y_{A}).

The following applies based on the equation of continuity in fluid mechanics:

$$A ( y ) \cdot {v}_{L} ( y ) = A ( {y}_{A} ) \cdot {v}_{L} ( {y}_{A} ) {⟶}^{z = const .} x ( y ) \cdot {v}_{L} ( y ) = {x}_{A} ( {y}_{A} ) \cdot {v}_{L} ( {y}_{A} ) \qquad ( 1 )$$

The following is obtained from this:

$$x ( y ) = {x}_{A} ( {y}_{A} ) \cdot \frac{\sqrt{2 \cdot g \cdot {y}_{A}}}{\sqrt{2 \cdot g \cdot y}} \\ and \text{/} or \\ x ( y ) = {x}_{A} ( {y}_{A} ) \cdot \sqrt{\frac{{y}_{A}}{y}} . \qquad ( 2 )$$

If the cross section and/or the width x in the embodiment according to FIG. 1 is realized according to the last-mentioned formula, then the air speed equals the drop speed without air resistance, thus avoiding the speed dispersion. The channel 20 is left open in the upper region and the side wall 28 does not reach up to y=0. As a result of the impact surface 30 and the low speed in the range of y=0, the error that occurs is negligible.

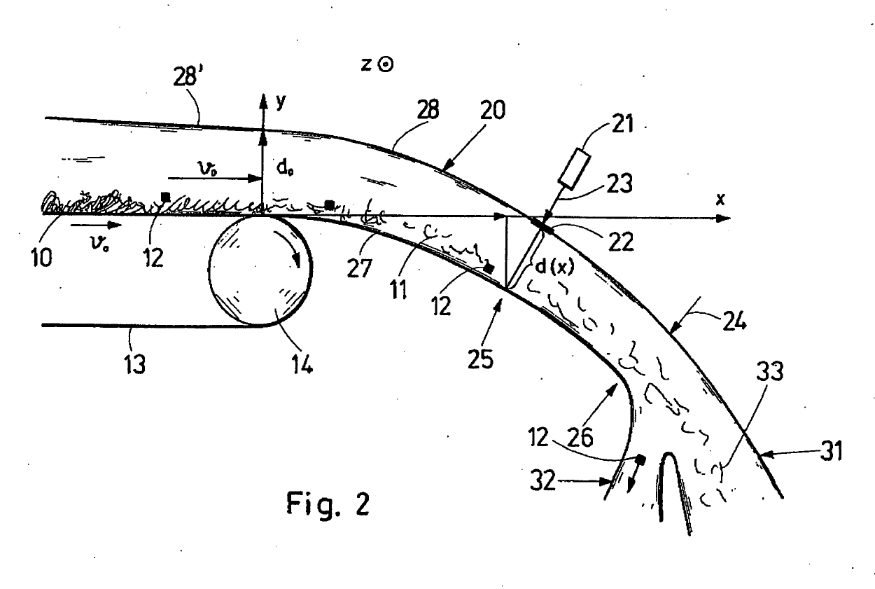

FIG. 2 shows an embodiment where the material flow 10 on the conveyor belt 13 moves with the speed vₒ at the location where the material flow 10 leaves the conveyor belt 13. The material flow 10 then follows a parabolic flight trajectory downward, toward the right side of FIG. 2, wherein the surface of conveyor belt 13 is again at the height level y=0. At point x=0 and y=0, the material in the material flow 10 leaves the surface of the conveyor belt 13 and moves along a parabolic flight trajectory. Without air resistance, the material in the material flow 10 moves along a parabolic trajectory which can be described by means of the following dependencies:
x=v₀·t
vₓ=v₀ (speed in x direction)

$${v}_{y} = - g \cdot \frac{x}{{v}_{0}} ( speed in y direction )$$

From this it follows:

$$v = \sqrt{{v}_{0}^{2} + {( g \cdot \frac{x}{{v}_{0}} )}^{2}}$$

The embodiment shown in FIG. 2 shows a flow of air generated above the material and/or by the material in the material flow 10, wherein the airflow speed and direction match the speed and direction of the material flow in channel 20. This can be achieved by using the following formula to change the width d(x) of channel 20, having a corresponding rectangular channel cross section and a constant depth z:

$$d ( x ) = \frac{{d}_{0}}{\sqrt{1 + \frac{{g}^{2}}{{v}_{0}^{4}} {x}^{2}}} \qquad ( 3 )$$

wherein d(x) should behave accordingly, at least in the region between the scanning zone 25 and the separating-out location 26.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. A method for separating out foreign bodies from a material flow, comprising:
generating a material flow;
transferring the material flow to a measuring section;
detecting at least one foreign body in the material flow at the measuring section;
removing the foreign body from the material flow; and
moving an airflow along with and at substantially the same speed as the material flow between the detecting and removing steps.

2. The method according to claim 1, further including allowing the material flow to follow a free-fall trajectory in the measuring section.

3. The method according to claim 1, allowing the material flow in the measuring section to follow a parabolic flight trajectory.

4. The method according to claim 1, wherein the moving step includes blowing an airflow from the outside into the measuring section.

5. The method according to claim 1, wherein the moving step includes moving the material flow in the measuring section inside a channel, wherein the channel has a cross section in a movement direction of the material flow that is reduced, at least in some sections.

6. The method according to claim 5, wherein the cross-sectional area in the at least some sections is a function depending on the square root of the material flow drop depth.

7. An apparatus for separating out foreign bodies from a material flow, comprising:
a feeding device including a channel having an inlet for receiving the material flow and having an end with an outlet, the channel cross section being reduced in a movement direction of the material flow, at least in some sections;
a foreign body detection device having a scanning zone in the channel to detect foreign bodies in the material flow; and
a removing device having a separating out location at the outlet to separate out the foreign bodies from the material flow.

8. The apparatus according to claim 7, wherein the channel has a rectangular cross section.

9. The apparatus according to claim 7, wherein the channel is positioned substantially vertically, at least in some sections.

10. The apparatus according to claim 9, further including an impact surface disposed near the inlet of channel.

11. The apparatus according to claim 7, wherein the channel includes at least one wall that corresponds at least in some sections to a parabolic flight trajectory.

12. The apparatus according to claim 7, wherein the channel has a cross-sectional area in at least some sections that is a function depending on the square root of a drop depth for the material flow.

13. The apparatus according to claim 7, further including a device for generating suction air flow in the channel.

14. The apparatus according to claim 7, further including a device for generating blast air in the channel.
